(19) United States
(12) Patent Application Publication
(10) Pub. No.: US 2016/0091987 A1
(43) Pub. Date: Mar. 31, 2016

(54) PROJECTOR

(71) Applicant: Panasonic Intellectual Property Management Co., Ltd., Osaka (JP)

(72) Inventor: SATOSHI KAMIYA, Osaka (JP)

(21) Appl. No.: 14/859,197

(22) Filed: Sep. 18, 2015

(30) Foreign Application Priority Data
Sep. 26, 2014 (JP) 2014-197576
Aug. 28, 2015 (JP) 2015-168412

(51) Int. Cl. G06F 3/0346; G06F 3/01; G06K 9/00; H04N 9/31

(52) U.S. Cl. CPC G06F 3/0346; H04N 9/3185; G06F 3/017; G06K 9/00355

(57) ABSTRACT

The projector of the present disclosure has a projecting section, a detecting section, and a control section. The projecting section projects an output image. The detecting section detects distance data from the projecting section to a projection plane on which output image is projected, and detects user's pointing operation spatially. The control section calculates spatial positions, to which each pixel of an original image is projected, based on the distance data, and provides the original image with geometrical correction so as to obtain the output image. According to calculation result, the control section determines positional relation between a position pointed by the user's pointing operation and a pixel position in the original image.

### BACKGROUND

1. Technical Field

The present disclosure relates to a projector capable of accepting user's gesture operation.

2. Description of the Related Art

Patent literature 1 provides a projector which corrects the distortion of a projection image caused by focus adjustment, tilt projection, or the surface shape of a projection object, by arranging a plurality of cameras, and performs correction so as to match an image projected on a screen to the outer shape of the screen. Further, detecting a user's pointing position, the projector performs operation corresponding to an icon projected on the screen.

### CITATION LIST

### Patent Literature

PTL 1: Japanese Unexamined Patent Application Publication No. 2005-229415

### SUMMARY

To detect a user's pointing position, the projector disclosed in Patent literature 1 projects a plurality of target points on the screen and approximately determines a target point that is the closest from the user's pointing position as the coordinate indicating the user's pointing position. Such a determination causes a positional difference between the user's intention and the projector's recognition.

The present disclosure provides one-to-one correspondence between the user's pointing position and the position of an original image, which enables the user to perform touch operation without positional difference from a position intended by the user.

The projector of the present disclosure has a projecting section, a detecting section, and a control section. The projecting section projects an output image. The detecting section detects distance data from the projecting section to a projection plane on which output image is projected, and detects user's pointing operation spatially. The control section calculates spatial positions, to which each pixel of an original image is projected, based on the distance data, and provides the original image with geometrical correction so as to obtain the output image. According to calculation result, the control section determines positional relation between a position pointed by the user's pointing operation and a pixel position in the original image.

With the structure above, the projector of the present disclosure enables the user to use touch operation even on a geometrically corrected projection image without positional difference from a position intended by the user.

### BRIEF DESCRIPTION OF DRAWINGS

FIG. 1 is a view illustrating a state where the projector projects an image onto a wall;

FIG. 2 is a view illustrating a state where the projector projects an image onto a table;

FIG. 3 is a block diagram showing the electrical structure of the projector;

FIG. 4A is a block diagram showing the electrical structure of the distance detecting section;

FIG. 4B illustrates distance data obtained by the distance detecting section;

FIG. 5 is a block diagram showing the optical structure of the projector;

FIG. 6 illustrates the workings of the projector;

FIG. 7 is a flowchart illustrating the workings of the projector;

FIG. 8 is a flowchart illustrating the workings of the projector; and

FIG. 9 is a flowchart illustrating the workings of the projector.

### DETAILED DESCRIPTION OF THE PREFERRED EMBODIMENT

Hereinafter, an exemplary embodiment will be described in detail, with reference to the accompanying drawings. However, details beyond necessity (for example, descriptions on well-known matters or on substantially identical structures) may be omitted to eliminate redundancy from the description below for easy understanding of those skilled in the art. It is to be understood that the accompanying drawings and the description below are for purposes of full understanding of those skilled in the art and are not to be construed as limitation on the scope of the claimed invention.

### First Exemplary Embodiment

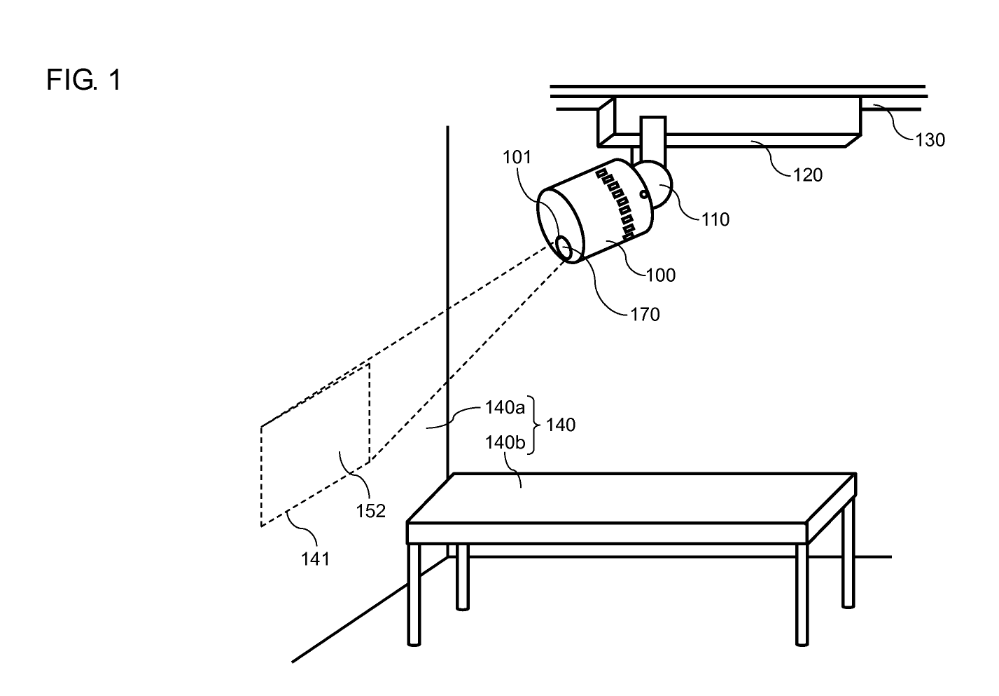

Hereinafter, the structure of the first exemplary embodiment will be described with reference to FIGS. 1 through 9.

### 1-1. Structure

### [1-1-1. General Structure]

Projector 100 having user interface 200 of the present disclosure will be described below.

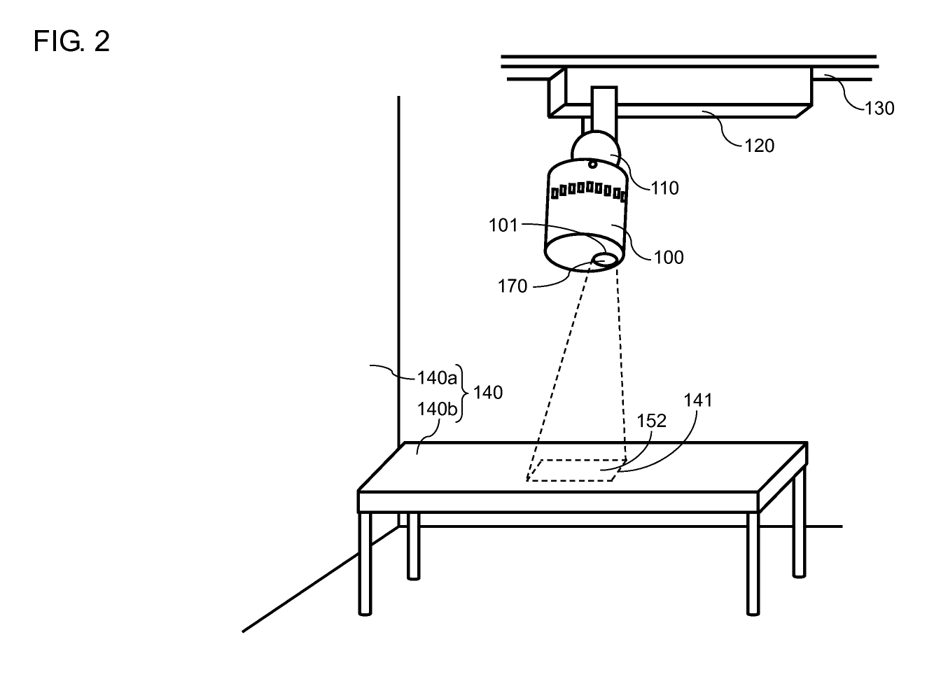

The general outline of image projection by projector 100 will be described with reference to FIGS. 1 and 2. FIG. 1 shows projector 100 projecting image onto wall 140a as projection surface 140. FIG. 2 shows projector 100 projecting image onto table 140b as projection surface 140.

As shown in FIGS. 1 and 2, projector 100 has projector section 170, driver section 110, and power source 120. Projector section 170 is connected to power source 120 via driver section 110. Power source 120 is fixed to wiring duct 130. The wires, which are electrically connected to each part of projector section 170 and driver section 110, are connected to power source such as an outlet via power source 120 and wiring duct 130. Through the wiring above, electric power is supplied to projector 100 and driver section 110. Projector section 170 has opening 101. Projector section 170 projects image through opening 101.

Driver section 110 can change the projecting direction of projector section 170. For example, in FIG. 1, driver section 110 drives projector section 170 so as to set its projecting direction toward wall 140a. This allows projector section 170 to project projection image 152 onto wall 140a. Similarly, in FIG. 2, driver section 110 drives projector section 170 so as to set its projecting direction toward table 140b. This allows projector section 170 to project projection image 152 onto table 140b. Driver section 110 may be manually driven on user's operation or automatically driven on a detection result of a predetermined sensor. The image projected on wall 140a may be different from, or the same as the image projected on table 140b.

Projector 100, since having user interface 200, provides users with an operational feeling as if projection area 141 of an image projected on projection surface 140 (i.e., wall 140a and table 140b) were a touch panel. This allows the user to have pointing operation by finger touch on the image projected on projection surface 140.

### [1-1-2. Structure of Projector]

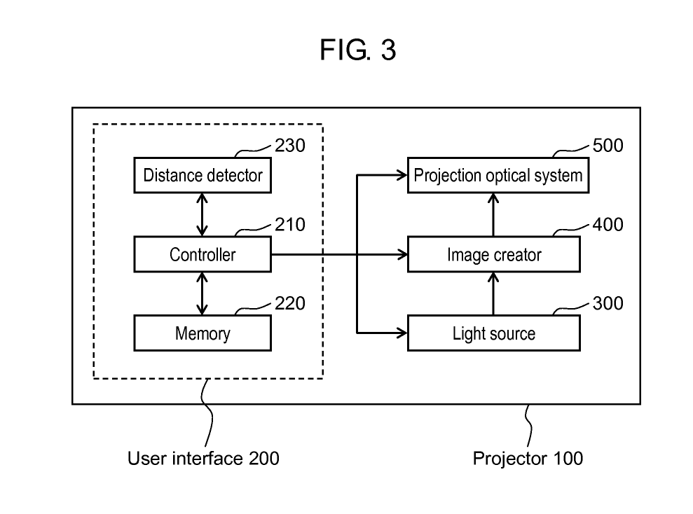

FIG. 3 is a block diagram showing the electrical structure of projector 100. Projector 100 has user interface 200, light source 300, image creator 400, and projection optical system 500. User interface 200 has controller 210, memory 220, and distance detector 230.

Controller 210 is a semiconductor device that controls the entire structure of projector 100; specifically, it controls the workings of memory 220 and distance detector 230 of user interface 200, light source 300, image creator 400, and projection optical system 500. Controller 210 may be formed of hardware only or combination of hardware and software.

Memory 220, which is a memory device for storing information, is formed of flash memory or ferroelectric memory, for example. Memory 220 stores control programs for controlling projector 100 (including user interface 200). Memory 220 also stores information fed from controller 210.

Distance detector 230, which is, for example, formed of a TOF (Time-of-Flight) sensor, detects the linear distance between the detector and a facing plane. When distance detector 230 faces wall 140a, it detects the distance between wall 140a and distance detector 230. Similarly, when distance detector 230 faces table 140b, it detects the distance between table 140b and distance detector 230.

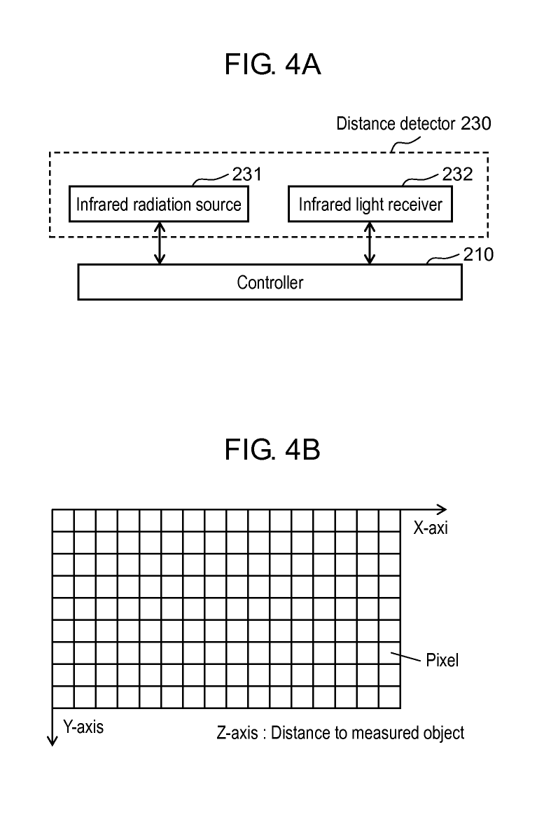

FIG. 4A is a block diagram showing the electrical structure of distance detector 230. As shown in FIG. 4A, distance detector 230 is formed of infrared radiation source 231 and infrared light receiver 232. Infrared radiation source 231 irradiates infrared detection light, and infrared light receiver 232 receives infrared detection light reflected off the facing plane. Infrared light source 231 irradiates infrared detection light through opening 101 so as to be scattered over the surrounding area. The infrared detection light irradiated from infrared light source 231 has a wavelength, for example, ranging from 850 nm to 950 nm.

Controller 210 stores the phase of infrared detection light irradiated from infrared light source 231 into memory 220. When the facing plane has a gradient or is not completely flat (which means the distance between the plane and distance detector 230 is different by position), a plurality of pixels arranged in the imaging area of infrared light receiver 232 receives light reflected off the facing plane at different timing. This causes difference in phase of infrared detection light when each pixel of infrared light receiver 232 receives light. Controller 210 stores each phase of infrared detection light received at each pixel of infrared light receiver 232 into memory 220.

Controller 210 reads data on phase from memory 220; specifically, it reads the phase of infrared detection light stored when infrared light source 231 irradiated the light, and the phase of infrared detection light stored when each pixel of infrared light receiver 232 received the light. According to the difference in phase of infrared detection light between the side of distance detector 230 and the side of infrared light receiver 232, controller 210 calculates the distance from distance detector 230 to the facing plane.

FIG. 4B illustrates distance data obtained by distance detector 230 (i.e., infrared light receiver 232). Distance detector 230 detects the distance on each pixel of infrared image 153 formed of the infrared detection light received by infrared light receiver 232. The pixel-to-pixel detection allows controller 210 to obtain the distance by pixel for the entire area of angle of view of infrared image 153 received by distance detector 230. In the description below, as shown in FIG. 4B, the X-axis represents the lateral direction of infrared image 153, the Y-axis represents the longitudinal direction thereof, and the Z-axis represents the detected distance direction. According to the result detected by distance detector 230, controller 210 obtains coordinate values (X, Y, Z) of three axes for each pixel of infrared image 153. In this way, controller 210 obtains distance data based on the result detected by distance detector 230.

In the description above, a TOF sensor is employed for distance detector 230, but it is not limited to; the distance may be calculated from difference in projected well-known patterns such as random-dot patterns or may be calculated from disparity of a stereo camera.

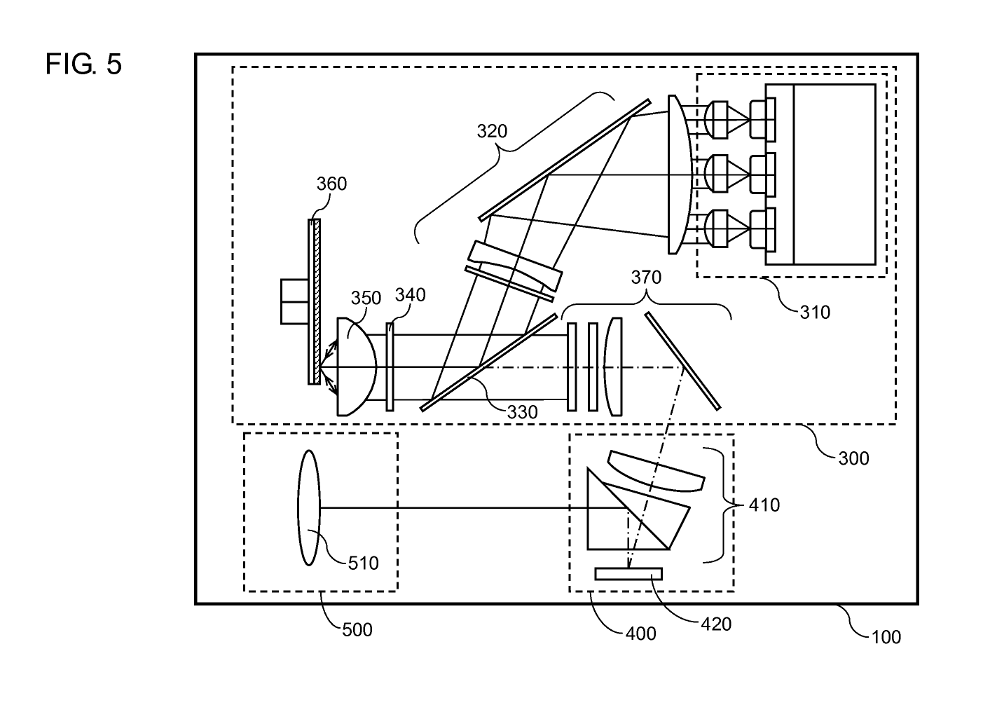

Next, the structure of light source 300, image creator 400, and projection optical system the components mounted projector 100 other than user interface 200 will be described with reference to FIG. 5. FIG. 5 is a block diagram showing the optical structure of projector 100. As shown in FIG. 5, light source 300 supplies image creator 400 with light for creating projection image 152. Image creator 400 outputs the image to projection optical system 500. Receiving the image created by image creator 400, projection optical system 500 provides the image with optical conversion such as focusing and zooming. Projection optical system 500 faces opening 101, and the image having undergone optical conversion is projected through opening 101. Projection optical system 500 corresponds to projector section 170 shown in FIG. 1 and FIG. 2.

First, the structure of light source 300 is described below. As shown in FIG. 5, light source 300 has semiconductor laser 310, dichroic mirror 330, λ/4 wave-plate (i.e., quarter-wave plate) 340, and phosphor wheel 360.

Semiconductor laser 310 is a solid light-source that emits, for example, S-polarized blue light having a wavelength of 440-455 nm. The S-polarized blue light fed from semiconductor laser 310 enters dichroic mirror 330 via light-guiding optical system 320.

Dichroic mirror 330 is an optical element with significantly different reflection and transmission properties at different wavelengths. For example, for S-polarized blue light having a wavelength of 440-455 nm, the mirror reflects it with a high reflectivity of 98% or more; on the other hand, for P-polarized blue light having a wavelength of 440-455 nm and for P-polarized green to red light having a wavelength of 490-700 nm, the mirror lets it through with a high permeability of 95% or more. Receiving S-polarized blue light emitted from semiconductor laser 310, dichroic mirror 330 reflects it toward quarter-wave plate 340.

Quarter-wave plate 340 is a polarization element that converts linearly-polarized light into circularly-polarized light, and vice versa. Quarter-wave plate 340 is disposed between dichroic mirror 330 and phosphor wheel 360. S-polarized blue light reflected off dichroic mirror 330 is converted into circularly-polarized blue light at quarter-wave plate 340 and then guided to phosphor wheel 360 through lens 350.

Phosphor wheel 360 is a rapidly rotatable aluminum disc. On the surface of phosphor wheel 360, a plurality of B-regions, G-regions, and R-regions is formed. The B-region is a diffuse reflection region. The G-region is a region on which a green-light-emitting phosphor is applied, and R-region is a region on which a red-light-emitting phosphor is applied. In the B-region of phosphor wheel 360, circularly-polarized blue light is reflected diffusely and goes back into quarter-wave plate 340. The circularly-polarized blue light is converted into P-polarized blue light, and then the light enters in dichroic mirror 330 again. The light, since being P-polarized light, passes through dichroic mirror 330 and travels via light-guiding optical system 370 to image creator 400.

When the circularly-polarized blue light hits the G-region of phosphor wheel 360, the phosphors on the G-region is excited by the light and emit green light. The green light emitted from the G-region travels to dichroic mirror 330 and passes it through, then reaches image creator 400 via light-guiding optical system 370. Similarly, when the circularly-polarized blue light hits the R-region of phosphor wheel 360, the phosphors on the R-region is excited by the light and emit red light. The red light emitted from the R-region travels to dichroic mirror 330 and passes it through, then reaches image creator 400 via light-guiding optical system 370.

Rapidly rotating phosphor wheel 360 allows the light fed from light source 300 to be fed as a time-shared output of blue light, green light, and redo light to image creator 400.

Image creator 400 creates a projection image suitable for an image signal received from controller 210. Image creator 400 has DMD (Digital-Mirror-Device) 420, for example. DMD 420 is a display element having a plurality of micromirrors in planar arrangement. Receiving an image signal from controller 210, DMD 420 deflects each of the micromirrors to provide incident light with spatial modulation.

From light source 300 to image creator 400, as described above, light in blue, green, and red is fed as a time-shared output. DMD 420 repeatedly receives, via light-guiding optical system 410, the light in blue, green, and red fed as a time-shared output. DMD 420 deflects each of the micromirrors in synchronization with the output timing of light in each color, by which image creator 400 creates projection image 152 corresponding to an image signal. According to an image signal, DMD 420 deflects the micromirrors so as to guide the light to either of within or without the effective range of projection optical system 500. Such created projection image 152 is fed from image creator 400 to projection optical system 500.

Projection optical system 500 has optical member 510 such as a focus lens and a zoom lens. Projection optical system 500 magnifies the light coming from image creator 400 and projects it onto projection surface 140.

The description above introduces the structure by a DLP (Digital-Light-Processing) method using DMD 420 as an example of projector 100, but the present disclosure is not limited to; a liquid crystal structure may be employed for projector 100.

Further, the description above introduces the structure of time-shared light source with use of phosphor wheel 360 of a single plate as an example of projector 100, but the present disclosure is not limited to; projector 100 may employ the light source of three plates each for blue, green, and red.

Further, the description above introduces the structure in which the light source of blue light for creating projection image 152 is disposed as a separated unit from the light source of infrared light for distance measurement, the present disclosure is not limited to; the two light-source above may be structured as an integrated unit. When the light source of three plates is employed, the light source for each color and the light source of infrared light may be integrated into one unit.

### 1-2. Workings and Effects

The workings of user interface 200 mounted on projector 100 will be described below.

Suppose that projector 100 projects an image onto a plane that is not completely parallel to the projector. In that case, projection without geometrical correction causes distortion in the image. To project an image in similarity relationship to the shape of original image 150 (i.e., the image fed into controller 210), original image 150 needs to have geometrical correction. Further, to use the user's finger as a pointing device for touching projection image 152 having undergone geometrical correction, an exact correspondence has to be determined between the finger touched position and the user's intended position in original image 150.

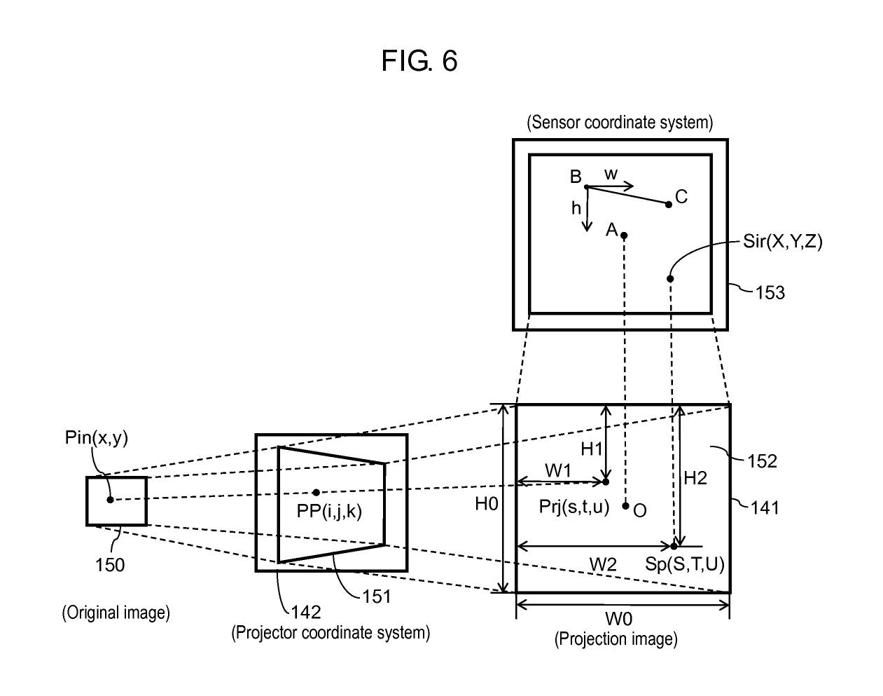

Hereinafter, the workings of projector 100 will be described with reference to FIG. 6 through FIG. 9.

[1-2-1. Conversion Process from Original Image to Projection Image via Geometrical Correction]

<Calculating Expression Representing Infrared Image on the Sensor Coordinate System>

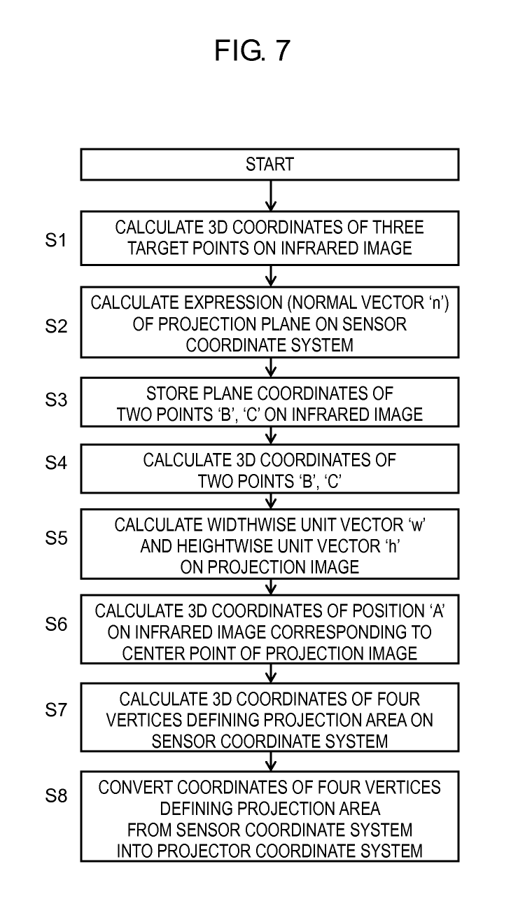

FIG. 6 illustrates the workings of user interface 200 of projector 100, and FIG. 7 is a flowchart thereof. In FIG. 6, point A on infrared image 153 of distance detector 230 indicates center point O of projection image 152 (or projection area 141). Controller 210 determines the plane coordinates of point A, and then determines three target points with equally-spaced intervals from point A. The number of target points may be three or more. In step S1 of FIG. 7, according to depth data (i.e., distance data) received from distance detector 230, controller 210 calculates 3D-coordinate (X, Y, Z) of each of the three target points on the sensor coordinate system (i.e., the coordinate system having distance detector 230 as the origin on coordinates). The plane coordinates on infrared image 153 correspond to the coordinates of pixels forming infrared image 153 of FIG. 4. The 3D coordinates on the sensor coordinate system correspond to the coordinates on projection surface 140 with reference to distance detector 230.

Next, in step S2, controller 210 represents projection surface 140 projected by projector 100 as an expression of a plane having normal vector n, based on the 3D coordinates of the three target points calculated in step S1.

<Calculating Projection Area on the Sensor Coordinate System>

In step S3, prior to calculation of a vector that indicates the width direction of the projection image, controller 210 determines two points B and C on infrared image 153 and stores each plane coordinate of points B, C into memory 220. The aforementioned two points are determined by controller 210 with use of an application of projector 100.

Next, in step S4, controller 210 calculates each 3D coordinate of points B, C from the following input values: each plane coordinate of points B and C on infrared image 153 stored in memory 220; and the depth data obtained by distance detector 230.

In step S5, controller 210, as shown in FIG. 6, calculates a 3D unit vector w that represents the width direction of projection image 152 from each 3D coordinate of points B and C calculated in step S4. Further, controller 210 calculates 3D unit vector h that represents the height direction of projection image 152 from an exterior product of vector w and normal vector n on projection surface 140 calculated in step S2. In the calculation process, controller 210 may calculate 3D unit vector h (representing the height direction) from each 3D coordinate of points B and C before the calculation of unit vector w. In that case, controller 210 calculates 3D unit vector w (representing the width direction of projection image 152) from an exterior product of 3D unit vector h (representing the height direction of projection image 152) and normal vector n on projection surface 140.

Controller 210 stores the following data in memory 220: the plane coordinate of point A on infrared image 153 corresponding to center point O of projection image 152; size W0 in the width direction of projection image 152 (projection area 141); and size H0 in the height direction thereof. The coordinate of point A, size W0, and size H0 are determined by controller 210 with use of an application of projector 100. In step S6, controller 210 calculates the 3D coordinate on the sensor coordinate system, which corresponds to the plane coordinate of point A on infrared image 153 stored in memory 220, based on the depth data received from distance detector 230.

Starting with the calculation of the 3D coordinate of point A, in step S7, controller 210 calculates each 3D coordinate of the four vertices that define image projection area 141 on the sensor coordinate system from unit vector w, unit vector h, size W0 in the width direction of projection image 152, and size H0 in the height direction thereof.

<Converting Sensor Coordinate System into Projector Coordinate System>

Projector 100 provides original image 150 with geometrical correction to produce output image 151, and outputs it from projector section 170 onto projection surface 140. To create output image 151 from original image 150 on the projector coordinate system, controller 210 has to convert each coordinate of the four vertices of projection area 141 (calculated in step S7) from on the sensor coordinate system into on the projector coordinate system.

Memory 220 has a parameter, in advance, that indicates a relative positional relationship between the projector coordinate system and the sensor coordinate system. In step S8, controller 210 converts the coordinates of the four vertices (calculated in step S7 shown in FIG. 7) of the projection area on the sensor coordinate system into the coordinates on the projector coordinate system.

### [1-2-2. Output Image Creating Process]

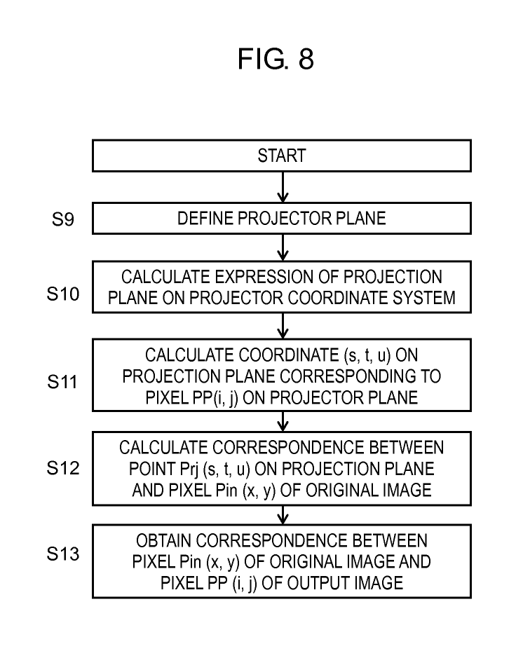

Next, the steps of creating output image 151 that projector 100 projects will be described with reference to FIG. 8.

In step S9, according to the number of pixels in both of the width and the height directions and angle of view of projector 100, controller 210 defines virtual projector plane 142 having arbitrary width and height. Projector plane 142 is for defining output image 151.

Next, in step S10, controller 210 calculates the expression for projection surface 140 on the projector coordinate system from each coordinate of the four vertices of projection area 141 on the projector coordinate system obtained in step S8 of FIG. 7.

Next, in step S11, controller 210 converts each pixel PP (i, j) on projector plane 142 into 3D coordinate (i, j, k) on the projector coordinate system. Further, with use of inverse projection transformation, controller 210 converts 3D coordinate (i, j, k) that corresponds to each pixel on projector plane 142 into the 3D coordinate of each point on projection surface 140, i.e., point Prj (s, t, u). The calculations above allow PP (i, j), i.e., the coordinate of each pixel of output image 151 to have one-to-one correspondence to Prj (s, t, u), i.e., the 3D coordinate on the projector coordinate system on projection surface 140.

Next, in step S12, controller 210 calculates distance W1, distance H1, ratio Wr, and ratio Hr. Distance W1 is the distance in the widthwise direction between point Prj (s, t, u) on projection surface 140 and one vertex out of the four vertices of projection area 141 calculated in step S8 of FIG. 7; similarly, distance H1 is the distance in the heightwise direction between the aforementioned two points. Ratio Wr represents the ratio of distance W1 to size W0 of projection area 141; similarly, ratio Hr represents the ratio of distance H1 to size H0 of projection area 141. That is, ratio Wr and ratio Hr are obtained by the following expressions: Wr=W1/W0, Hr=H1/H0.

To “put” original image 150 onto projection area 141 surrounded by the four vertices, controller 210 defines the correspondence between point Prj (s, t, u) on projection surface 140 and pixel Pin (x, y) of original image 150, based on ratios Wr, Hr, and the number of the pixels in the widthwise direction and in the heightwise direction of original image 150.

Further, in step S13, controller 210 defines the correspondence between pixel PP (i, j) of output image 151 and pixel Pin (x, y) of original image 150. Controller 210 substitutes an RGB level (pixel value) of pixel Pin (x, y) of original image 150 for that of pixel PP (i, j) of output image 151. Finally, controller 210 obtains geometrically corrected original image 150, i.e., obtains output image 151.

The processes described above allows projector 100 to project distortion-free image on a projection plane even when it is not disposed exactly parallel to the projector.

### [1-2-3. Calculating User's Finger-Touch Coordinates]

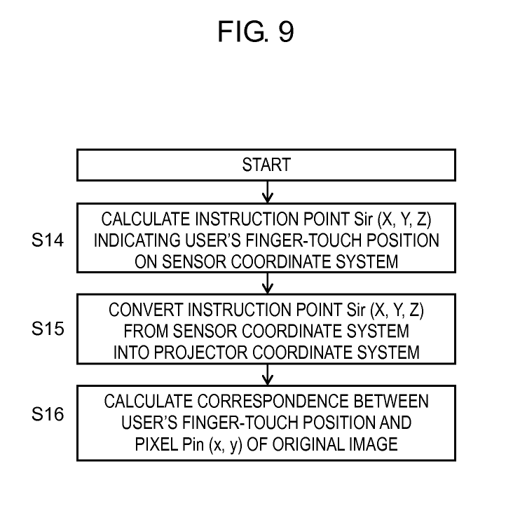

Hereinafter, the workings of projector 100 in response to user's instruction for example, a touching operation on an image projected on projection surface 140 will be described with reference to the flowchart of FIG. 9.

Receiving a touching operation on the projected image with a user's finger as a pointing device, controller 210 obtains the coordinate of instruction point Sir (X, Y) on the infrared image that corresponds to the position touched by the user. In step S14, based on the depth data obtained by distance detector 230, controller 210 calculates 3D coordinate (X, Y, Z) on the sensor coordinate system that corresponds to instruction point Sir (X, Y) on the infrared image.

Next, controller 210 performs coordinate transformation in step S15. Specifically, controller 210 converts instruction point Sir (X, Y, Z) on the sensor coordinate system into instruction point Sp (S, T, U) on the projector coordinate system.

In step S16, to define the correspondence between the finger-touch position and pixel Pin (x, y) of the original image, controller 210 calculates distance W2, distance H2, ratio Ws, and ratio Hs. Distance W2 is the distance in the widthwise direction between instruction point Sp (S, T, U) obtained in step S15 and one vertex out of the four vertices of the projection area on the projector coordinate system calculated in step S8 of FIG. 7; similarly, distance H2 is the distance in the heightwise direction between the aforementioned two points. Ratio Ws represents the ratio of distance W2 to size W0 of projection area 141; similarly, ratio Hs represents the ratio of distance H2 to size H0 of projection area 141. That is, ratio Ws and ratio Hs are obtained by the following expressions: Ws=W2/W0, Hs=H2/H0. To “put” original image 150 onto projection area 141 surrounded by the four vertices, controller 210 defines the correspondence between instruction point Sp (S, T, U) indicating the finger touch position and pixel Pin (x, y) of original image 150, based on ratios Ws, Hs, and the number of the pixels in the widthwise direction and in the heightwise direction of original image 150.

The calculations described above allows projector 100 to define one-to-one correspondence between the user's finger-touch position and the (pixel) position of original image 150, by which projector 100 recognizes correctly the user's intended position.

The structure of the first exemplary embodiment has been described as an example of technique disclosed in the present disclosure. However, the disclosed technique is not limited to the structure above but is applicable to an embodiment having changes and modifications. Further, another exemplary embodiment can be developed by combination of the components described in the first exemplary embodiment.

### INDUSTRIAL APPLICABILITY

The present disclosure is applicable to a projector capable of recognizing user's pointing operation on a projected image, even on a geometrically corrected image.

What is claimed is:

1. A projector comprising:
a projecting section for projecting an output image;
a detecting section for detecting distance data from the projecting section to a projection plane on which the output image is projected, and for detecting user's pointing operation spatially; and
a control section for calculating spatial positions, to which each pixel of an original image is projected, based on the distance data, and for providing the original image with geometrical correction so as to obtain the output image,
wherein, according to calculation result, the control section determines positional relation between a position pointed by the user's pointing operation and a position of the pixel in the original image.

2. The projector according to claim 1, wherein the control section calculates a 3D coordinate, which represents the position pointed by the user's pointing operation, based on the distance data received from the detecting section.

3. The projector according to claim 2, wherein the control section calculates 3D coordinates of four vertices that determine a projection area in which the output image is projected on the projection plane.

4. The projector according to claim 3, wherein the control section calculates a widthwise distance and a heightwise distance from the position pointed by the user's pointing operation to any given one vertex of the four vertices that determine the projection area, and defines correspondence between the position pointed by the user's pointing operation and the position of the pixel in the original image based on a ratio of the calculated widthwise distance to a width of the projection area and a ratio of the calculated heightwise distance to a height of the projection area.
